(19) United States
(12) Patent Application Publication
(10) Pub. No.: US 2005/0205529 A1
(43) Pub. Date: Sep. 22, 2005

(54) Calibration system for laser peening

(75) Inventor: Andre Claudet, Albuquerque, NM (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/086,201

(22) Filed: Mar. 21, 2005

Related U.S. Application Data
(60) Provisional application No. 60/555,184, filed on Mar. 22, 2004.

(51) Int. Cl. B23K 26/00

(52) U.S. Cl. 219/121.6; 700/166; 219/121.85

(57) ABSTRACT

A system for laser peening a workpiece. The system comprises a world coordinate frame, a robot operatively connected to the world coordinate frame for moving the workpiece relative, a calibration tool operatively connected to the robot for determining a multiplicity of data points of the workpiece, a computer for storing and using the multiplicity of data points of the workpiece, and a laser system for laser peening the workpiece using the multiplicity of data points.

### CROSS-REFERENCE TO RELATED APPLICATIONS

This application claims the benefit of U.S. Provisional Patent Application No. 60/555,184 filed Mar. 22, 2004 and titled “Inspection System for Laser Peening.” U.S. Provisional Patent Application No. 60/555,184 filed Mar. 22, 2004 and titled “Inspection System for Laser Peening” is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to laser peening and more particularly to a calibration system for laser peening.

2. State of Technology

The state of laser peening technology is illustrated in part by the following patents and patent applications owned by Metal Improvement Company, Inc.: European Patent No. EP1478062; United Kingdom Patent No. GB2401719; and U.S. Patent Application No. 2004/0228376. For example, United States Patent Application No. 2004/0228376 to Metal Improvement Company, Inc. and the Regents of the University of California, for self-seeded single-frequency solid-state ring laser, for a single-frequency laser peening method and system using same, published Nov. 18, 2004, provides the following state of technology information: “The use of mechanical shocks to form metals and to improve their surface properties has been realized for ages. In current industrial practice, a peening treatment of metal surfaces is accomplished by using high velocity shot. Treatment improves surface properties and very importantly for many applications, results in a part displaying significantly improved resistance to fatigue and corrosion failure. A wide range of components are shot peened in the aerospace and automotive industries. However, for many applications, shot peening does not provide sufficiently intense or deep treatment or cannot be used because of its detrimental effect on the surface finish. With the invention of the laser, it was rapidly recognized that the intense shocks required for peening could be achieved by means of a laser-driven tamped plasma. B. P. Fairand, et al., “Laser Shot Induced Microstructural and Mechanical Property Changes in 7075 Aluminum,” Journal of Applied Physics, Vol. 43, No. 9, p. 3893, September 1972. Typically, a plasma shock of 10 kB to 30 kB is generated at metal surfaces by means of high energy density (about 200 j/cm 2), short pulse length (about 30 nanoseconds) lasers.” (Paragraphs [0006] and [0007], United States Patent Application No. 2004/0228376).

The state of laser peening technology is illustrated in part by the following patents owned by the Regents of the University of California: U.S. Pat. Nos. 6,410,884; 6,657,160; 6,805,970; and 6,818,854. For example, U.S. Pat. No. 6,805,970, for laser peening of components of thin cross-section, issued Jan. 19, 2004 to Lloyd A. Hackel, John M. Halpin, and Fritz B. Harris, Jr. and assigned to the Regents of the University of California, provides the following state of technology information: “The system for laser peening a part is shown. The near field output of a beam from a laser is image relayed by the optical imaging system to the part to be peened . . . . The part is peened with an acoustic coupling material, shock absorbing layer. The laser beam output comprises a rectangular beam that allows precise and uniform overlap of pulses and hence highly uniform compressive stress from front to back side within the part. This minimizes distortion of the peened part. The part is positioned within the system by the part manipulator.” (Col. 5, lines 16-37, U.S. Pat. No. 6,805,970).

The state of measuring probe technology is illustrated in part by the following patents and patent applications owned by Renishaw plc: U.S. Pat. Nos. 4,819,491; 5,402,981; 5,435,072; 6,275,053; 6,301,796; 6,633,051; 6,810,597; 6,839,563; RE37,030; and United States Patent Application No. 2004/0219886. For example, U.S. Pat. No. 5,402,981 for a workpiece measuring machine, issued Jan. 19, 2004 to David R. McMurtry and assigned to Renishaw plc provides the following state of technology information: “A variety of forms of measuring machine are currently in use each of which is more or less suited to carry out measurements on workpieces as diverse as small engineering piece parts, and large scale parts such as car bodies or aircraft wings. These have conveniently been classified into ten categories in a report commencing on page 11 of the ASME standard reference ASME B89.1.12M-1990, the categories including the well-known bridge machines, gantry machines, or cantilever machines. The machines may have either fixed or moving tables on which the workpiece is carried. The philosophy behind the design of the machines has always been that the table used for supporting the workpiece has to be relatively massive, (traditionally a large granite slab) in order to avoid distortions occurring when heavy workpieces are mounted on the table. This has been particularly so in the moving bridge machines in which the tracks on which the bridge moves are formed on the table. Thus the table also has to be rigid enough to avoid distortions due to the movements of the bridge, which itself is a relatively massive structure in order to support the other moving parts of the machine.” (Col. 1, lines 9-32, U.S. Pat. No. 5,402,981).

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a system for laser peening a workpiece. The system utilizes a world coordinate frame, a calibration tool for determining a multiplicity of data points of the workpiece, a robot operatively connected to the world coordinate frame for moving the calibration tool relative to the workpiece for determining the multiplicity of data points, a computer for storing and using the multiplicity of data points, and a laser system for laser peening the workpiece using the multiplicity of data points.

In another embodiment, a system for laser peening a workpiece utilizes a world coordinate frame, a calibration tool for determining a first multiplicity of data points of the workpiece, a touch-trigger probe for determining a second multiplicity of data points of the workpiece, a robot operatively connected to the world coordinate frame for moving the calibration tool relative to the workpiece for determining the first multiplicity of data points and moving the workpiece relative to the touch-trigger probe for determining a second multiplicity of data points of the workpiece, a computer for storing and using the first and second multiplicity of data points, and a laser system for laser peening the workpiece using the first and second multiplicity of data points.

The system for laser peening a workpiece has use in situations where a robot or machine tool manipulates a workpiece and uses a fixed tool. The tool can be, for example, a point in a laser beam, a cutting tool or an EDM electrode. For example, the system for laser peening a workpiece can be used for laser peening for jet engine components.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 is a schematic illustration of one embodiment of an inspection system for laser peening constructed in accordance with the present invention.

FIG. 2 is a schematic illustration of the laser peening portion of the system for laser peening constructed in accordance with the present invention.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

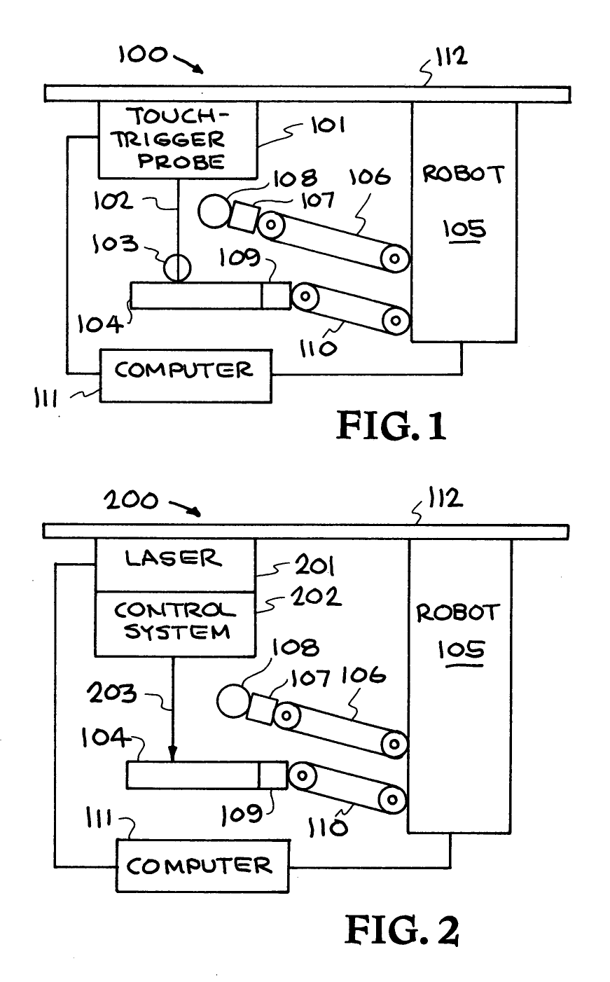

Referring now to the drawings and in particular to FIG. 1, a schematic illustration of one embodiment of an inspection system for laser peening incorporating the present invention is shown. The inspection system of this embodiment is designated generally by the reference numeral 100. The inspection system 100 for laser peening includes the following structural components: a touch-trigger probe 101, a stylus 102, a probing sphere 103, a robot 105, a robot wrist 106, a calibration tool 107, a high-precision sphere 108, a workpiece holder 109, a robot wrist 110, a computer 111, and a world coordinate frame 112.

The inspection system 100 for laser peening comprises hardware and software to determine the coordinate frame transformation between a workpiece 104 and the robot 105 that will subsequently be used for laser peening the workpiece 104. The touch-trigger probe 101 and the robot 105 are rigidly mounted in fixed relation to the world coordinate frame 112. The touch-trigger probe 101, the stylus 102, and the probing sphere 103 are rigidly mounted in fixed relation to the world coordinate frame 112. The robot 105, the robot wrist 106, the calibration tool 107, and the high-precision sphere 108 are also rigidly mounted in fixed relation to the world coordinate frame 112. Also, the robot 105, the robot wrist 110, the workpiece holder 109, and the workpiece 104 are rigidly mounted in fixed relation to the world coordinate frame 112.

The first set of hardware components are the calibration tool 107 that mounts to the robot 105 by robot wrist 106. This tool has a larger, high-precision sphere 108 on it and the relationship between the robot wrist 106 and high-precision sphere 108 is known.

The second set of hardware components of the system 100 are the touch-trigger probe 101 that has a stylus 102 with a probing sphere 103 at its end. The probe 101 can detect when the probing sphere 103 is displaced from its nominal position by very small amounts. That is, it detects when something contacts the probing sphere 103. The probe 101 is mounted in a fixed position in the world coordinate frame 112.

The structural components of the inspection system 100 for laser peening having been described and illustrated in FIG. 1, the construction and operation of the inspection system for laser peening 100 will now be described. The inspection system for laser peening 100 comprises a system to determine the coordinate frame transformation between the workpiece 104 attached to the robot wrist 110 of the robot 105 and the coordinate system comprising (1) the robot 105, the robot wrist 106, the calibration tool 107, and the high-precision sphere 108; and (2) the touch-trigger probe 101, the stylus 102, and the probing sphere 103.

The position of the probing sphere 103 relative to the world coordinate frame 112 is measured. The workpiece 104 is gripped by the robot 105 and the workpiece 104 is moved so that the probing sphere 103 contacts several datum surfaces of the workpiece 104. The position of the probing sphere 103 in the coordinate system is determined for each contact point and a first set of data points are obtained. The information is stored in computer 111 for further use.

The calibration tool 107 is used to determine a second set of data points. The high-precision sphere 108 is used to contact several datum surfaces of the workpiece 104. The first data points and the second data points are used to compute a full six degrees of freedom coordinate transformation between the robot 105 and the workpiece 104. In addition, the known geometric characteristics of the workpiece 104 can be used to compute a full six degrees of freedom coordinate transformation between the robot 105 and the workpiece 104. The information is stored in computer 111 for further use.

The software portion of the system 100 in the computer 111 comprises a procedure to find the center of the probing sphere 103 of the touch trigger probe 101, procedures to both manually and automatically acquire the first set of data points where the probing sphere 103 contacts the workpiece 104, procedures to both manually and automatically acquire the second set of data points where the high-precision sphere 108 contacts the workpiece 104, and a workpiece specific set of calculations to determine the coordinate frame transformation. Enough data points are acquired to fully constrain the workpiece in six degrees of freedom. The coordinate transformation between the workpiece, the world coordinate frame 112, and the robot 105 is computed from the recorded contact data points by computer 111. The coordinate transformation between the workpiece 104 and the world coordinate frame 112, and robot 105 is used for further processing where the workpiece 104 is acted on by the laser peening system illustrated in FIG. 2.

The inspection system for laser peening 100 was developed to improve the Laser Peening process. The inspection system for laser peening 100 was first used in a laboratory on a low pressure fan blade workpiece 104 for a jet engine. A problem with laser peening of fan blades 104 is that the aerofoil geometry can vary due to manufacturing or use. Thus, when the blade 104 is gripped by the robot 105 on the aerofoil section the relationship between the treatment area at the blade root and the robot wrist 110 can also vary. These variations can be large enough to significantly affect the placement of the spot pattern onto the workpiece.

Referring now to FIG. 2, a schematic illustration of the laser peening portion of the system incorporating the present invention is shown. The laser peening portion of the system is designated generally by the reference numeral 200. The laser peening portion 200 of the system includes the following structural components: a laser 201 for laser peening, a laser beam control system 202, a laser peening beam 203, the workpiece 104, the computer 111, the workpiece holder 109, the robot wrist 110, and the world coordinate frame 111. Also shown in FIG. 2 are the robot 105, the robot wrist 106, the high-precision sphere 108, and the calibration tool 107 that were used to obtain data points for the laser peening operation.

The laser peening system 200 comprises the structural components listed above and software. The software comprises a procedure to find the center of the high-precision sphere 108, procedures to both manually and automatically acquire the points where the high-precision sphere 108 contacts the surfaces of the workpiece 104, and a workpiece specific set of calculations to determine the coordinate frame transformation.

The structural components of the laser peening portion 200 of the system having been described and illustrated in FIG. 2, the construction and operation of the laser peening portion system 200 will now be described. As described above, the coordinate transformation information between the workpiece 104 and the high-precision sphere 108 has been stored in the computer 111 and is used by the laser peening system 200 to laser peen the workpiece 104.

Given that the high-precision sphere 108 is in a know/position in space relative to the world coordinate frame 111 and the robot 105, the coordinate transformation information that has been stored in the computer 109 is used by the laser peening system 200 to provide instructions to the laser 201 to laser peen the workpiece 104. The computer 109 implements the procedure that has tracked the high-precision sphere 108 and the workpiece 104 to laser peen the workpiece 104. With the location of the high-precision sphere 108 known, the workpiece is gripped by the robot 105 and moved so that the laser 201 laser peens the workpiece 104 as instructed by the computer 111. The laser 201 focuses the laser peening beam 203 onto the workpiece 104 using the laser beam control system 202. The laser peening beam 203 can be used to increase the surface hardness of the workpiece 104 using shock propagation induced by laser pulses or to accomplish other operations on the workpiece 104.

In another embodiment, the information obtained by the probing sphere 103 of the touch trigger probe 101 is used to by the laser peening system 200 to laser peen the workpiece 104. The software comprises a procedure to find the center of the probing sphere 103, procedures to both manually and automatically acquire the points where the probing sphere 103 contacts the surfaces of the workpiece 104, and a workpiece specific set of calculations to determine the coordinate frame transformation. Given that the probe 101 is fixed in space relative to the world coordinate frame 111, the coordinate transformation information that has been stored in the computer 109 is used by the laser peening system 200 to provide instructions to the laser 201 to laser peen the workpiece 104. The computer 109 implements the procedure that has tracked the probing sphere 103 of the touch trigger probe 101 and the workpiece 104 to laser peen the workpiece 104. With the location of the probe sphere center 103 known, the workpiece is gripped by the robot 108 and moved so that the laser 201 laser peens the workpiece 104 as instructed by the computer 109. The laser 201 focuses the laser peening beam 203 onto the workpiece 104 using the laser beam control system 202. The laser peening beam 203 can be used to increase the surface hardness of the workpiece 104 using shock propagation induced by laser pulses or to accomplish other operations on the workpiece 104.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. An apparatus for obtaining a multiplicity of data points of a workpiece for laser peening the workpiece, comprising,
a world coordinate frame,
a robot operatively connected to said world coordinate frame at a fixed point relative to said world coordinate frame,
a calibration tool operatively connected to said robot for determining the multiplicity of data points of the workpiece, and
a computer for storing the multiplicity of data points of the workpiece.

2. The apparatus for obtaining a multiplicity of data points of a workpiece for laser peening the workpiece of claim 1 wherein said calibration tool includes a high-precision sphere and a robot wrist operatively connected to said robot.

3. The apparatus for obtaining a multiplicity of data points of a workpiece for laser peening the workpiece of claim 1 including a laser system for laser peening the workpiece using the multiplicity of data points of the workpiece.

4. The apparatus for obtaining a multiplicity of data points of a workpiece for laser peening the workpiece of claim 1 including a touch-trigger probe operatively connected to said world coordinate frame for determining the multiplicity of data points of the workpiece.

5. The apparatus for obtaining a multiplicity of data points of a workpiece for laser peening the workpiece of claim 1 wherein said robot moves the workpiece relative to said touch-trigger probe for determining data points of the workpiece relative to said touch-trigger probe and said world coordinate frame.

6. The apparatus for obtaining a multiplicity of data points of a workpiece for laser peening the workpiece of claim 1 wherein said touch-trigger probe includes a sphere for determining the multiple data points of the workpiece in relation to said touch-trigger probe and said world coordinate frame.

7. The apparatus for obtaining a multiplicity of data points of a workpiece for laser peening the workpiece of claim 1 wherein said laser system includes a laser beam control system for moving a laser peening beam for laser peening the workpiece.

8. A method of laser peening a workpiece, comprising the steps of:
providing a world coordinate frame,
providing a robot,
using a calibration tool operatively connected to said robot for determining the multiplicity of data points of the workpiece, and
laser peening the workpiece using said multiple data points to move the workpiece relative to a laser peening beam.

9. The method of laser peening a workpiece of claim 8 including using a touch-trigger probe to determine the multiple data points of the workpiece.
